(19) United States
(12) Patent Application Publication
(10) Pub. No.: US 2026/0318269 A1
(43) Pub. Date: Oct. 15, 2026

(54) Two-Stroke Engine, Portable Working Machine, And Engine Intake Device

(71) Applicant: YAMABIKO CORPORATION, Tokyo (JP)

(72) Inventors: Hisato ONODERA, Ohme-shi (JP); Yuya FUJII, Ohme-shi (JP); Takuma NAKA, Ohme-shi (JP); Masaki KIHARA, Ohme-shi (JP); Yoshifumi SAKASHITA, Ohme-shi (JP)

(21) Appl. No.: 19/642,796

(22) Filed: Apr. 9, 2026

(30) Foreign Application Priority Data
Apr. 15, 2025 (JP) 2025-066695

(51) Int. Cl. F02M 35/10; F02B 75/02; F02M 19/02; F02M 35/02; F02M 35/024

(52) U.S. Cl. CPC F02M 35/1019; F02B 75/02; F02M 19/02; F02M 35/0201; F02M 35/024; F02B 2075/025

(57) ABSTRACT

A two-stroke engine has a structure for reducing the pulsation influences. A diaphragm-type carburetor of the two-stroke engine includes a gas supply passage supplying, to a primary chamber, air introduced into a secondary-side space through an air filter, a metering chamber storing fuel, a diaphragm, and a communication passage separated from the metering chamber by the diaphragm. When pressure in the gas supply passage becomes negative, the fuel is introduced into the gas supply passage from the metering chamber, and an air-fuel mixture of the fuel and the air is supplied to the primary chamber. One end of the communication passage is disposed in the secondary-side space. The two-stroke engine further includes an extension pipe that is added to one end of the communication passage and communicates with the communication passage. An end of the extension pipe on a side opposite the communication passage is opened in the secondary-side space.

### CROSS-REFERENCE TO RELATED APPLICATIONS

This application claims the benefit of Japanese Patent Application No. 2025-066695 filed on Apr. 15, 2025, in the Japanese Patent Office, the disclosure of which is herein incorporated in its entirety by reference.

### BACKGROUND

### Technical Field

The present invention relates to a two-stroke engine, a portable working machine, and an engine intake device.

### Related Art

A device including a two-stroke engine is described in Japanese Laid-open patent publication No. 2001-263073, for example.

In a two-stroke engine, the inside of a crankcase becomes a positive pressure as a piston moves toward the bottom dead center, and conversely, the inside of the crankcase becomes a negative pressure as the piston moves toward the top dead center.

In a two-stroke engine, when the inside of the crankcase becomes a positive pressure, an air-fuel mixture inside the crankcase that serves as a primary chamber may flow back toward a carburetor side to some extent. Thus, as for flow of the air-fuel mixture inside the carburetor, a state in which the air-fuel mixture smoothly flows from the carburetor side to the crankcase side and a state in which the air-fuel mixture flows back from the crankcase side to the carburetor side are periodically repeated.

Such periodic airflow motion is referred to as pulsation.

There is a possibility that, due to pulsation, a state in which the concentration of the air-fuel mixture is excessively high is periodically repeated.

When pulsation becomes large, output of the engine may decrease and its rotational speed may become unstable.

The present invention has been made in view of the above-described problem and provides a two-stroke engine having a structure capable of reducing an influence of pulsation, a portable working machine including the two-stroke engine, and an engine intake device.

### SUMMARY

According to the present invention, there is provided a two-stroke engine including a diaphragm-type carburetor and an air cleaner, in which

the air cleaner includes an air filter,

the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the two-stroke engine further includes an extension pipe that is added to the one end of the communication passage and communicates with the communication passage, and

an end of the extension pipe on a side opposite to the communication passage is opened in the secondary-side space.

In addition, according to the present invention, there is provided a portable working machine including a two-stroke engine including a diaphragm-type carburetor and an air cleaner, in which

the air cleaner includes an air filter,

the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the two-stroke engine further includes an extension pipe that is added to the one end of the communication passage and communicates with the communication passage, and

an end of the extension pipe on a side opposite to the communication passage is opened in the secondary-side space.

In addition, according to the present invention, there is provided an engine intake device including a diaphragm-type carburetor and an air cleaner, in which

the air cleaner includes an air filter,

the diaphragm-type carburetor includes a gas supply passage that supplies, to a primary chamber of the engine, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the engine intake device further includes an extension pipe that is added to the one end of the communication passage and communicates with the communication passage, and

an end of the extension pipe on a side opposite to the communication passage is opened in the secondary-side space.

According to the present invention, it is possible to reduce an influence of pulsation.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a perspective view of a brush cutter (portable working machine) according to an embodiment;

FIG. 2 is a cross-sectional view of a device body of the brush cutter according to the embodiment;

FIG. 3 is an exploded perspective view of a main configuration of a two-stroke engine according to the embodiment;

FIG. 4 is a cross-sectional view of a main part of the two-stroke engine according to the embodiment;

FIG. 5 is a side view of a case, an opposing plate, and an extension pipe of the two-stroke engine according to the embodiment when viewed from one side;

FIG. 6 is a side view of the opposing plate and the extension pipe of the two-stroke engine according to the embodiment when viewed from the other side;

FIG. 7 is a cross-sectional view in an axial direction of the extension pipe;

FIG. 8 is a diagram illustrating results confirming stability of the amount of carbon monoxide emission in the brush cutter according to the embodiment;

FIG. 9 is a diagram illustrating results confirming stability of the amount of carbon monoxide emission in a brush cutter according to a reference embodiment; and

FIG. 10 is a side view of the case, the opposing plate, and the extension pipe of a two-stroke engine according to a modification when viewed from one side.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

An embodiment of the present invention will be described below with reference to the accompanying drawings. In all drawings, similar constituent components are denoted by the same reference sign, and description may be omitted as appropriate.

### Embodiment

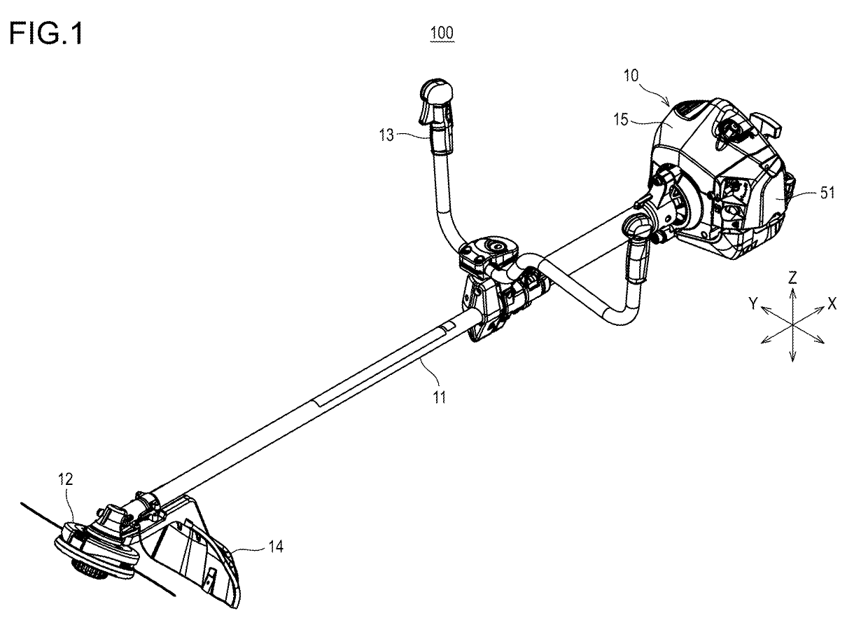

First, the embodiment will be described with reference to FIGS. 1 to 9.

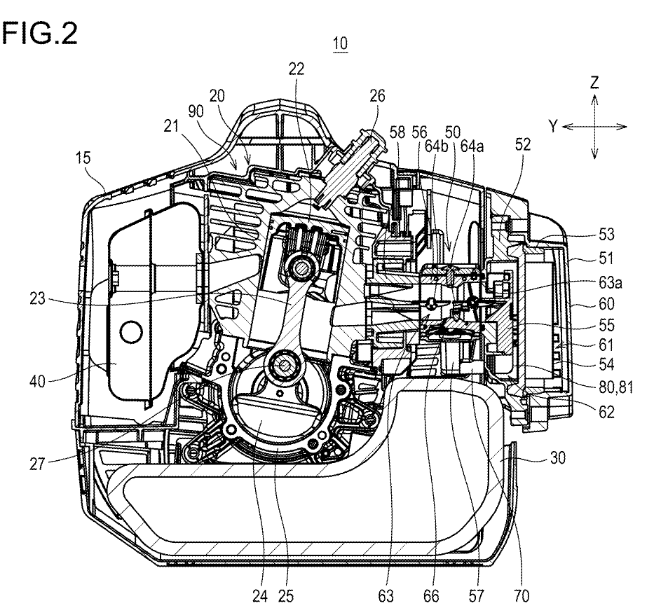

As illustrated in FIG. 2, a two-stroke engine 90 according to the present embodiment includes a diaphragm-type carburetor 50 and an air cleaner 60.

The air cleaner 60 includes an air filter 54.

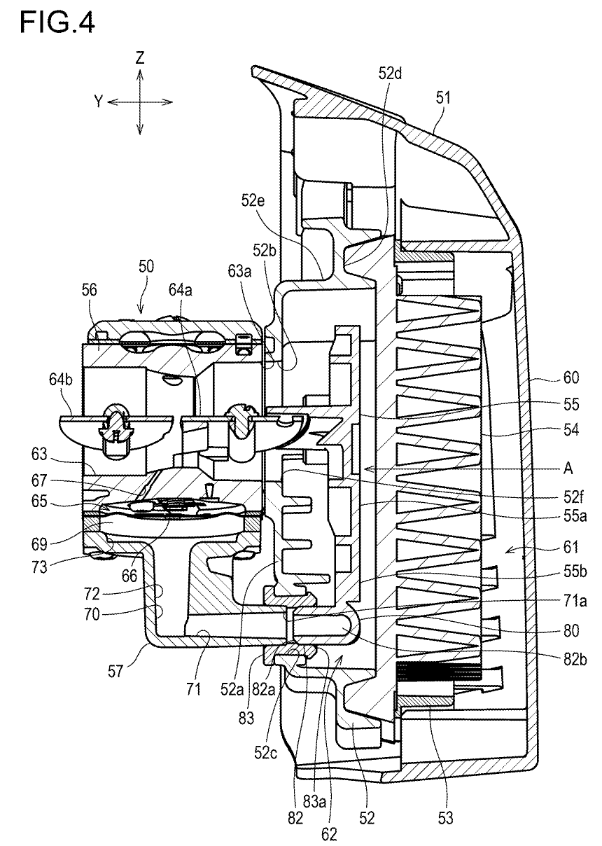

The diaphragm-type carburetor 50 includes a gas supply passage 63 that supplies, to a primary chamber (for example, inside of a crankcase 25), air introduced into a secondary-side space (secondary-side space 62) of the air filter 54 through the air filter 54, a metering chamber 65 (FIG. 4) that stores fuel supplied from a fuel tank 30, a diaphragm 66 (FIG. 4), and a communication passage 70 that is separated from the metering chamber 65 by the diaphragm 66.

When the gas supply passage 63 becomes a negative pressure, the fuel is introduced from the metering chamber 65 into the gas supply passage 63, and an air-fuel mixture in which the fuel and the air are mixed is supplied to the primary chamber.

One end (opening part 71a (FIG. 4)) of the communication passage 70 is disposed in the secondary-side space 62.

The two-stroke engine 90 further includes an extension pipe 80 that is added to the one end of the communication passage 70 and communicates with the communication passage 70.

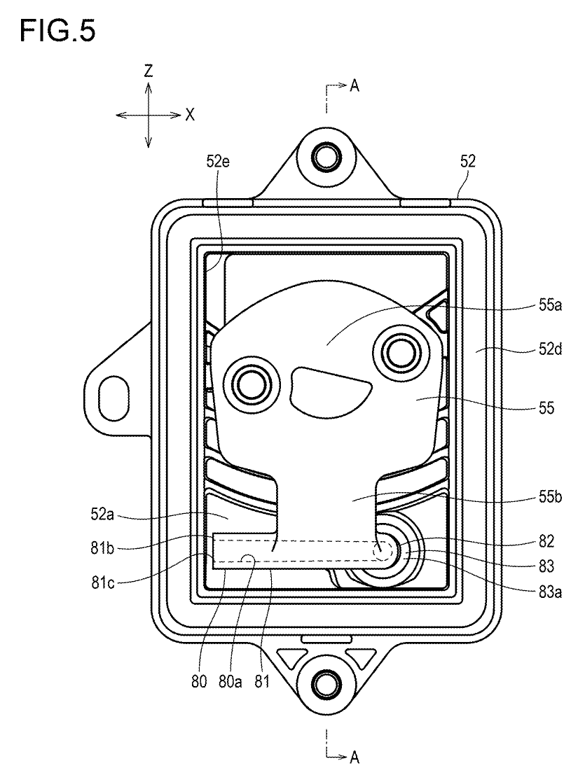

An end (other end 81b illustrated in FIG. 5) of the extension pipe 80 on a side opposite to the communication passage 70 is opened in the secondary-side space (secondary-side space 62).

A portable working machine (for example, a brush cutter 100) according to the present embodiment includes the two-stroke engine 90 according to the present embodiment.

An engine intake device according to the present embodiment is a part constituted by the diaphragm-type carburetor 50 and the air cleaner 60 among constituent components included in the two-stroke engine 90 according to the present embodiment. Specifically, the engine intake device according to the present embodiment is an engine intake device, including the diaphragm-type carburetor 50 and the air cleaner 60. The air cleaner 60 includes the air filter 54. The diaphragm-type carburetor 50 includes the gas supply passage 63 that supplies, to the primary chamber of the engine, air introduced into the secondary-side space of the air filter 54 through the air filter 54, the metering chamber 65 that stores fuel supplied from the fuel tank 30, the diaphragm 66, and the communication passage 70 that is separated from the metering chamber 65 by the diaphragm 66. When the gas supply passage 63 becomes a negative pressure, the fuel is introduced from the metering chamber 65 into the gas supply passage 63, and an air-fuel mixture in which the fuel and the air are mixed is supplied to the primary chamber. One end of the communication passage 70 is disposed in the secondary-side space. The engine intake device further includes the extension pipe 80 that is added to the one end of the communication passage 70 and communicates with the communication passage 70. The end (other end 81b) of the extension pipe 80 on the side opposite to the communication passage 70 is opened in the secondary-side space.

When the gas supply passage 63 becomes a negative pressure, the diaphragm 66 is displaced in a direction in which fuel in the metering chamber 65 is ejected into the gas supply passage 63 through a fuel nozzle 67.

The inside of the metering chamber 65 and the inside of the gas supply passage 63 are always maintained substantially at the same pressure.

A region including the communication passage 70 and an inner-cavity region 80a of the extension pipe 80 can be referred to as a compensator passage, and the compensator passage is separated from the metering chamber 65 by the diaphragm 66.

A structure (compensator structure) including such a compensator passage is widely known and disclosed in, for example, Japanese Patent Laid-open No. 03-202665. A compensator structure in the present embodiment is the same as the compensator structure disclosed in Japanese Patent Laid-open No. 03-202665 in terms of its basic structure and basic principle (basic operation).

Since the compensator passage is separated from the metering chamber 65 by the diaphragm 66 as described above, the internal pressure of the compensator passage shifts to a more negative pressure than its previous state when the diaphragm 66 is displaced in a direction in which fuel in the metering chamber 65 is ejected. When the internal pressure of the compensator passage shifts to a negative pressure, the diaphragm 66 is displaced in a direction in which fuel ejection from the metering chamber 65 is suppressed.

Accordingly, by providing the compensator passage, an excessive increase in the amount of fuel ejection from the metering chamber 65 is suppressed (as compared to a case where the compensator passage is not provided), (thereby contributing to stabilization of the amount of fuel ejection).

The gas supply passage 63 and the compensator passage communicate with each other through the secondary-side space 62. In other words, the compensator passage is not a closed system isolated from the gas supply passage 63.

The negative pressure generated in the gas supply passage 63 also acts on a space 69 (separated from the metering chamber 65 by the diaphragm 66) of the communication passage 70, which will be described later, through the secondary-side space 62 and the compensator passage. The negative pressure operates to eliminate a pressure difference generated between the space 69 and the metering chamber 65.

As described above, there is a possibility that, due to pulsation, a state in which the concentration of the air-fuel mixture is excessively high is periodically repeated.

In particular, as the air filter 54 becomes clogged, the secondary-side space 62, and consequently, the gas supply passage 63 shift to a negative pressure. As a result, the concentration of fuel tends to increase. However, due to the presence of the compensator passage, the diaphragm 66 can be displaced in a direction in which excessive fuel ejection is suppressed.

According to examinations by the inventors of the present application, there is an extremely strong need for reduction of the size and weight of a two-stroke engine incorporated in a small-sized (handheld or the like) working device such as a brush cutter or a chain saw. There is a need to configure a device body 10 as compactly as possible, and it tends to be difficult to secure a sufficient space around the carburetor. Thus, it has not always been easy to secure a sufficient passage length for the compensator passage. Furthermore, although the fuel tank 30, the air cleaner 60, and the like are provided around the carburetor, periodic operations are required in the surrounding space, such as refueling and periodic cleaning of an air cleaner filter (air filter 54). In order to secure this working space, even when an additional member is provided outside the carburetor, it is needed to configure the additional member as compactly as possible. On the other hand, when the passage length of the compensator passage is insufficient, the inside of the compensator passage becomes an excessively negative pressure, and the amount of fuel ejection is potentially excessively suppressed. In this case, variation in the amount of fuel ejection due to pulsation described above becomes extreme. In other words, the amount of fuel ejection becomes more susceptible to influence of pulsation.

In addition, during backflow due to pulsation, the diaphragm is also pushed by pressure acting through the compensator passage (pressure acting through the gas supply passage, the secondary-side space, and the compensator passage), and the amount of fuel ejection probability increases.

In contrast, according to the present embodiment, the two-stroke engine 90 includes the extension pipe 80 that is added to the one end of the communication passage 70 and communicates with the communication passage 70, and the end (other end 81b) of the extension pipe 80 on the side opposite to the communication passage 70 is opened in the secondary-side space 62.

Accordingly, the passage length of the compensator passage (total of the passage length of the communication passage 70 and the tube length of the extension pipe 80) can be easily secured, and the amount of fuel ejection can be easily optimized (stabilized). In other words, the concentration of the air-fuel mixture can be stabilized, and thus influence of pulsation can be effectively suppressed.

In pulsation, as for flow of the air-fuel mixture inside the gas supply passage 63, a state in which the air-fuel mixture smoothly flows from the gas supply passage 63 side to a cylinder 21 side and a state in which the air-fuel mixture flows back from the cylinder 21 side to the gas supply passage 63 side are periodically repeated.

If the timing of fuel ejection from the metering chamber 65 to the gas supply passage 63 overlaps the timing of backflow from the cylinder 21 side to the gas supply passage 63 side, the high-concentration air-fuel mixture potentially flows back to the secondary-side space 62 side or adheres to the air filter 54.

According to examinations by the inventors of the present application, it has been found that the phase of pulsation can be adjusted by settings of the volume, thickness, passage length, and the like of the compensator passage.

According to the present embodiment, by sufficiently ensuring the passage length of the compensator passage, it becomes easy to adjust (delay) the phase of pulsation and synchronize the timing of fuel ejection from the metering chamber 65 to the gas supply passage 63 and the timing of smooth flowing from the gas supply passage 63 side to the cylinder 21 side (in the next period).

In other words, in the two-stroke engine 90 according to the present embodiment, the volume, thickness, passage length, and the like of the compensator passage are set so as to synchronize the timing of fuel ejection from the metering chamber 65 to the gas supply passage 63 and the timing of smooth flowing from the gas supply passage 63 side to the cylinder 21 side.

Note that, since influence of pulsation due to clogging of the air filter 54 can be suppressed, disposition of a pre-filter at a prior stage of the air filter 54 may be omitted in the present embodiment. As a result, the size of the brush cutter 100 can be reduced.

More detailed description is given below.

The two-stroke engine 90 according to the present embodiment is typically incorporated and used in a handheld working device such as a brush cutter or a chain saw, in other words, a portable working machine. However, the present invention is not limited to this example, and the two-stroke engine 90 may also be used in a device other than a handheld working device.

A case where the two-stroke engine 90 is incorporated in the brush cutter 100 is taken as an example in the following description of the embodiment.

As illustrated in FIG. 1, the brush cutter 100 according to the present embodiment includes, for example, the device body 10, a shaft 11 that extends in one direction from the device body 10, a rotating portion 12 that is provided at a distal end portion of the shaft 11, and an operation handle 13 that is provided on the shaft 11 and grasped by a user.

The device body 10 includes a body case 15 constituting its outer shell. Note that the body case 15 is constituted by, for example, a plurality of components, one of which is a filter cover 51 to be described later.

The device body 10 includes the two-stroke engine 90.

Drive power of the two-stroke engine 90 is transmitted to the rotating portion 12 through a drive transmission mechanism provided on the shaft 11 so that the rotating portion 12 rotates. Cutting of a target object such as grasses becomes possible by rotation of the rotating portion 12.

A guard portion 14 that prevents grasses or the like cut by the rotating portion 12 from flying toward the user is provided at a position on a side on which the operation handle 13 and the device body 10 are disposed with respect to the rotating portion 12.

For convenience of description, an X direction, a Y direction, and a Z direction illustrated in FIGS. 1 to 7 are used in the following description.

The X direction, the Y direction, and the Z direction are orthogonal to one another.

The X direction is the extending direction of the shaft 11.

The user of the brush cutter 100 typically uses the brush cutter 100 while grasping the operation handle 13 in a posture in which the operation handle 13 is positioned above the shaft 11.

When the user grasps the operation handle 13 in front of his or her body and uses the brush cutter 100 in a posture in which the distal end of the shaft 11 (portion where the rotating portion 12 is provided) is positioned further forward than the operation handle 13, the X direction is a substantially rearward and forward direction with respect to the user, and the Y direction is a substantially leftward and rightward direction with respect to the user. The Z direction is a substantially upward and downward direction. Thus, in the following description, the X direction is also referred to as a front-rear direction, the Y direction is also referred to as a right-left direction, and the Z direction is also referred to as an up-down direction.

The X direction is illustrated as a bidirectional arrow, and in the bidirectional arrow, a direction to which a character (X) is attached is also referred to as the positive X direction, and a direction in which no character is attached is also referred to as the negative X direction. The positive X direction may be referred to as a rear side, and the negative X direction may be referred to as a front side.

Similarly, the Y direction is illustrated as a bidirectional arrow, and in the bidirectional arrow, a direction to which a character (Y) is attached is also referred to as the positive Y direction, and a direction to which no character is attached is also referred to as the negative Y direction. The positive Y direction may be referred to as a right side, and the negative Y direction may be referred to as a left side.

Similarly, the Z direction is illustrated as a bidirectional arrow, and in the bidirectional arrow, a direction to which a character (Z) is attached is also referred to as the positive Z direction, and a direction to which no character is attached is also referred to as the negative Z direction. The positive Z direction may be referred to as an upper side, and the negative Z direction may be referred to as a lower side.

As illustrated in FIG. 2, the two-stroke engine 90 included in the device body 10 is referred to as a two-cycle engine and includes an engine block 20, the diaphragm-type carburetor 50, the air cleaner 60, the fuel tank 30, and an exhaust unit 40.

The engine block 20 is also referred to as a cylinder block and includes the cylinder 21, a piston 22 that is housed in the cylinder 21 so as to be reciprocable, the crankcase 25 having an inner-cavity region that communicates with the cylinder 21, a crank web 24 that is provided in the crankcase 25, a connecting rod 23 that couples the crank web 24 and the piston 22, a crank pin 27 that is provided integrally with the crank web 24, and an ignition plug 26.

FIG. 2 is a cross-sectional view taken along a plane including a central axis of the connecting rod 23.

In the engine block 20 of the two-stroke engine 90, the piston 22 makes one reciprocating motion for each cycle.

An intake passage for supplying the air-fuel mixture from the gas supply passage 63 to the crankcase 25, a scavenging passage that connects the cylinder 21 and the crankcase 25, and an exhaust passage for exhausting gas from the cylinder 21 are formed in a side surface of the cylinder 21.

In an air-fuel mixture scavenging engine, in a process in which the piston 22 moves toward the top dead center, the air-fuel mixture is introduced from the intake passage into the crankcase 25 since the inside of the crankcase 25 becomes a negative pressure. In the latter half of the process, the air-fuel mixture is compressed in the cylinder 21 in a state in which an exhaust port and a scavenging port are blocked by the piston 22.

As the air-fuel mixture ignited by a spark of the ignition plug 26 in the cylinder 21 combusts (explodes), the piston 22 moves toward the bottom dead center. In the latter half of the process, the exhaust passage and the scavenging passage are released from the blocked state by the piston 22, and accordingly, exhaust through the exhaust passage is started, and intake from the crankcase 25 into the cylinder 21 through the scavenging passage is performed.

When the piston 22 moves toward the bottom dead center, the inside of the crankcase 25 becomes a positive pressure.

The fuel tank 30 stores fuel (liquid fuel) such as gasoline inside. The fuel in the fuel tank 30 is supplied to the engine block 20 through the diaphragm-type carburetor 50.

Gas exhausted from the engine block 20 is introduced into the exhaust unit 40 and then exhausted outside.

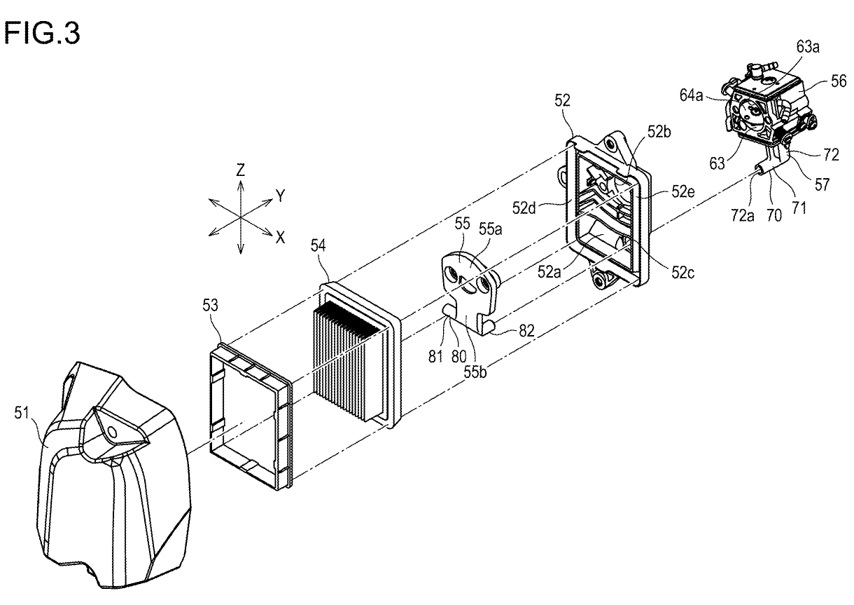

As illustrated in FIG. 3, the two-stroke engine 90 includes the air filter 54 that filters external air, the filter cover 51 that covers the outer side of the air filter 54, a case 52 that forms the secondary-side space 62 (FIG. 4) between the case 52 and the air filter 54, a frame 53 that is attached around the air filter 54, an opposing plate 55 that is provided in the case 52, an upstream-side supply-passage constituting member 56 inside which the gas supply passage 63 (upstream portion thereof) is formed, a downstream-side supply-passage constituting member 58 (FIG. 2) inside which the gas supply passage 63 (downstream portion thereof) is formed, and a communication-passage constituting member 57 inside which the communication passage 70 is formed.

The case 52 includes a main wall portion 52a having a flat plate shape. The main wall portion 52a has a plate surface facing, for example, the Y direction.

The case 52 further includes a surrounding wall 52e that stands up in the negative Y direction from a peripheral portion of the main wall portion 52a, and a groove 52d that is formed in a circumferential shape outside the surrounding wall 52e.

The case 52 includes, for example, a plurality of standing portions that stand up from the main wall portion 52a toward the secondary-side space 62 (in the negative Y direction).

A first through-hole 52b and a second through-hole 52c that each penetrate through the main wall portion 52a (in the Y direction) are formed in the main wall portion 52a of the case 52.

Air in the secondary-side space 62 is introduced into the gas supply passage 63 through the first through-hole 52b.

The extension pipe 80 and the communication passage 70 are coupled to each other inside the second through-hole 52c by a joint member 83 (FIG. 4) to be described later.

Note that one end 83a of the joint member 83, which is an end on the secondary-side space 62 side is positioned in the secondary-side space 62. The extension pipe 80 is added to the one end 83a of the joint member 83 and communicates with the joint member 83 and the communication passage 70.

The air filter 54 is assembled to the case 52 with a peripheral portion thereof being disposed in the groove 52d of the case 52.

The opposing plate 55 includes a main surface portion 55a having a flat plate shape. The main surface portion 55a has a plate surface facing, for example, the Y direction.

In the present embodiment, the extension pipe 80 is integrated with the opposing plate 55.

The opposing plate 55 includes, in addition to the main surface portion 55a, for example, a coupling portion 55b that is narrower than the main surface portion 55a, and the main surface portion 55a is coupled to the extension pipe 80 through the coupling portion 55b.

More specifically, the extension pipe 80 is integrally molded with the opposing plate 55. For example, the extension pipe 80 and the opposing plate 55 are integrally molded of a resin material such as hard nylon. Such hard nylon may be, for example, PA6.

A member including the opposing plate 55 and the extension pipe 80 is substantially rigid. Thus, the member including the opposing plate 55 and the extension pipe 80 can be accurately and easily attached to the case 52.

The shape of the extension pipe 80 is not limited and may be, for example, a straight tubular shape. However, in the present embodiment, the extension pipe 80 is bent.

Accordingly, freedom in disposing the extension pipe 80 improves, and for example, the extension pipe 80 with a necessary length can be disposed in the secondary-side space 62 formed in a flat shape in the case 52.

The extension pipe 80 is formed in, for example, an L shape.

More specifically, the extension pipe 80 includes an extending portion 81 and an intersecting portion 82, each having a straight tubular shape. An axial direction of the extending portion 81 and an axial direction of the intersecting portion 82 are orthogonal to each other. In other words, an axial direction of an inner-cavity region of the extending portion 81 and an axial direction of an inner-cavity region of the intersecting portion 82 are orthogonal to each other. Note that the inner-cavity region 80a of the extension pipe 80 is a total of the inner-cavity region of the extending portion 81 and the inner-cavity region of the intersecting portion 82.

For example, the axial direction of the extending portion 81 extends in the X direction, and the extending portion 81 is disposed along a surface on the negative Y side of the main wall portion 52a.

For example, the axial direction of the intersecting portion 82 extends in the Y direction. A portion on the positive Y side of the intersecting portion 82 is inserted in the second through-hole 52c (FIG. 4).

The opposing plate 55 may include a protruding portion that protrudes in the positive Y direction from a surface on the positive Y side of the main surface portion 55a. The protruding portion protrudes, for example, into the first through-hole 52b.

The upstream-side supply-passage constituting member 56 has a through-hole penetrating through the upstream-side supply-passage constituting member 56 in the Y direction. The through-hole constitutes the upstream portion of the gas supply passage 63.

A choke valve 64a and a throttle valve 64b are provided inside the upstream portion of the gas supply passage 63. Among the choke valve 64a and the throttle valve 64b, the choke valve 64a is disposed on the upstream side (air cleaner 60 side), and the throttle valve 64b is disposed on the downstream side.

For example, the communication-passage constituting member 57 is provided in the negative Z direction relative to the upstream-side supply-passage constituting member 56.

As illustrated in FIG. 4, the air filter 54, the frame 53, and the opposing plate 55 are disposed inside the filter cover 51, and substantially the entirety of the case 52 is also disposed inside the filter cover 51.

As illustrated in FIG. 4, a space defined (surrounded) by the main wall portion 52a and the surrounding wall 52e of the case 52 and the air filter 54 is the secondary-side space 62.

Among internal spaces of the filter cover 51, a space positioned on the outer side through the air filter 54 with respect to the secondary-side space 62 is a primary-side space 61.

External air is introduced from outside of the filter cover 51 (from outside of the brush cutter 100) into the primary-side space 61, and then, is introduced into the secondary-side space 62 through the air filter 54.

The external air introduced into the secondary-side space 62 is introduced into the gas supply passage 63 through the first through-hole 52b of the main wall portion 52a.

The main surface portion 55a of the opposing plate 55 is disposed to face the first through-hole 52b, and covers the entirety of the first through-hole 52b (and an upstream end 63a of the gas supply passage 63) when viewed in the positive Y direction. The main surface portion 55a is disposed between the first through-hole 52b (and the upstream end 63a of the gas supply passage 63) and the air filter 54.

Accordingly, even when the air-fuel mixture flowing back through the gas supply passage 63 due to pulsation reaches the secondary-side space 62 through the upstream end 63a and the first through-hole 52b, the air-fuel mixture can be drawn again toward the gas supply passage 63 by the main surface portion 55a. Thus, contamination of the air filter 54 by the air-fuel mixture can be suppressed.

In this manner, the two-stroke engine 90 includes the opposing plate 55 that is disposed to face the upstream end 63a of the gas supply passage 63 and provided in the secondary-side space (secondary-side space 62), and the extension pipe 80 is integrated with the opposing plate 55.

Accordingly, the number of components of the two-stroke engine 90 can be reduced, and the extension pipe 80 can be assembled to the case 52 simultaneously in a single operation of assembling the opposing plate 55 to the case 52. Thus, assembly operations of the opposing plate 55 and the extension pipe 80 can be performed in a smaller number of processes.

In particular, since the entirety of the member integrally including the opposing plate 55 and the extension pipe 80 is rigid, assembly of the member can be accurately and easily performed.

Moreover, detachment of the extension pipe 80 from the case 52 due to vibration, oil adhesion to the extension pipe 80, and the like can be effectively suppressed.

The main wall portion 52a of the case 52 is disposed adjacent to (in contact with or in proximity to) a surface on the negative Y side of the upstream-side supply-passage constituting member 56. In other words, this is a structure in which the case 52 is directly connected to the upstream-side supply-passage constituting member 56.

Specifically, the two-stroke engine 90 includes the case 52 that defines the secondary-side space (secondary-side space 62) together with the air filter 54, and the supply-passage constituting members (upstream-side supply-passage constituting member 56 and downstream-side supply-passage constituting member 58) including the gas supply passage 63, and the case 52 and the supply-passage constituting member are disposed adjacent to each other.

The direct connection of the supply-passage constituting member and the case 52 makes it difficult to secure the passage length of the communication passage 70. However, since the extension pipe 80 includes a portion disposed inside the secondary-side space 62, a sufficient passage length can be secured as a total of the passage length of the communication passage 70 and the tube length of the extension pipe 80.

In the present embodiment, the entirety of the extension pipe is disposed in the secondary-side space (secondary-side space 62).

Accordingly, arrangement in which the extension pipe 80 does not interfere with the air filter 54 can be achieved.

As illustrated in FIG. 4, the gas supply passage 63 is partially constricted inside the upstream-side supply-passage constituting member 56, and constitutes a venturi tube.

The diaphragm-type carburetor 50 includes the fuel nozzle 67 having one end opened at a constricted portion of the gas supply passage 63.

The other end side of the fuel nozzle 67 communicates with the metering chamber 65.

Fuel is supplied from the fuel tank 30 to the metering chamber 65 through a non-illustrated fuel passage.

When the gas supply passage 63 (in particular, the constricted portion) becomes a negative pressure, the fuel temporarily stored in the metering chamber 65 is ejected in the form of mist toward the inside of the gas supply passage 63 through the fuel nozzle 67.

The downstream portion of the gas supply passage 63 is formed inside the downstream-side supply-passage constituting member 58 (FIG. 2) that is adjacently disposed in the positive Y direction relative to the upstream-side supply-passage constituting member 56. In other words, the downstream-side supply-passage constituting member 58 has a through-hole penetrating through the downstream-side supply-passage constituting member 58 in the Y direction, and the through-hole constitutes the downstream side of the gas supply passage 63.

In this manner, an axial direction of the gas supply passage 63 extends in, for example, the Y direction. Thus, the axial direction of the gas supply passage 63 and the main wall portion 52a of the case 52 intersect (for example, orthogonal to) each other.

As described above, the diaphragm-type carburetor 50 includes the diaphragm 66.

As illustrated in FIG. 4, one surface (for example, upper surface) of the diaphragm 66 defines a part of the metering chamber 65 (lower wall surface of the metering chamber 65 as illustrated in FIG. 4, for example).

In FIG. 4, the space 69 below the diaphragm 66 (space between the diaphragm 66 and the communication-passage constituting member 57) constitutes a part of the communication passage 70 (end portion on the diaphragm 66 side).

In other words, the other surface (for example, lower surface) of the diaphragm 66 defines a part of the space 69 (upper wall surface of the space 69 as illustrated in FIG. 4, for example).

The space 69 communicates with parts (an enlarged-diameter portion 73, a second part 72, and a first part 71 to be described later) of the communication passage 70 other than the space 69.

The communication-passage constituting member 57 is provided on a side (lower side as illustrated in FIG. 4, for example) opposite the space 69 with respect to the diaphragm 66.

For example, part (for example, most) of the communication passage 70 is formed inside the communication-passage constituting member 57.

Specifically, a series of passages, namely the first part 71, the second part 72, and the enlarged-diameter portion 73 are formed inside the communication-passage constituting member 57, and these portions constitute part (for example, most) of the communication passage 70.

The first part 71 extends in, for example, the Y direction. Among parts of the communication-passage constituting member 57 that have the first part 71 inside, at least a part on the intersecting portion 82 side (part in the negative Y direction) is formed in a straight tubular shape and extends in the Y direction. An inner-cavity region of the first part 71 is enlarged in, for example, the negative Y direction.

The second part 72 extends in, for example, the Z direction. An inner-cavity region of the second part 72 is enlarged in, for example, the positive Z direction.

The enlarged-diameter portion 73 is further enlarged than an end portion on the positive Z side of the second part 72.

In the communication-passage constituting member 57, a part including the first part 71 is coupled to the intersecting portion 82 of the extension pipe 80 through the joint member 83 in a sleeve shape (tubular shape).

Specifically, the part including the first part 71 in the communication-passage constituting member 57 is fitted and fixed in the joint member 83 from one side (left side in FIG. 4) of the joint member 83, and a part on one end 82a side of the intersecting portion 82 is fitted and fixed in the joint member 83 from the other side (right side in FIG. 4) of the joint member 83.

In this manner, the first part 71 and the inner-cavity region of the intersecting portion 82 communicate with each other.

The joint member 83 is fixed to the second through-hole 52c of the case 52.

The first part 71 and the inner-cavity region of the intersecting portion 82 are disposed coaxially with each other (aligned with each other).

FIG. 5 is a side view of the case 52, the opposing plate 55, and the extension pipe 80 when viewed in the direction of arrow A (positive Y direction) illustrated in FIG. 4. FIG. 4 is a cross-sectional view along line A-A illustrated in FIG. 5. FIG. 2 is a cross-sectional view tilted relative to line A-A, for example.

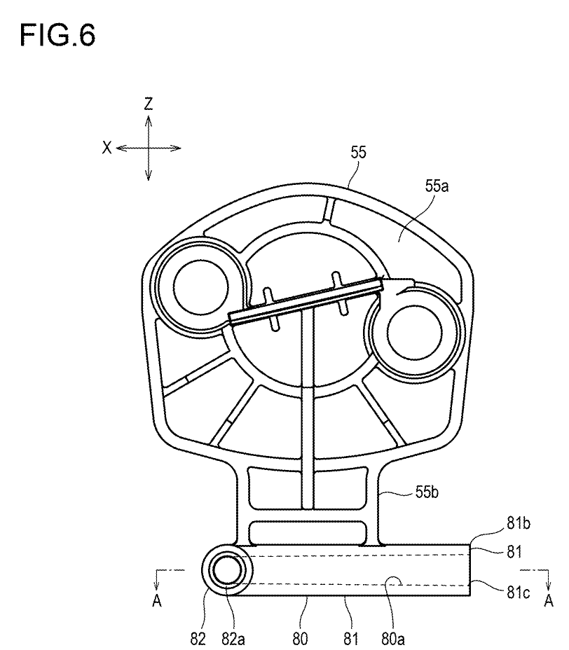

FIG. 6 is a side view of the opposing plate 55 (integrated with the extension pipe 80) when viewed in the negative Y direction.

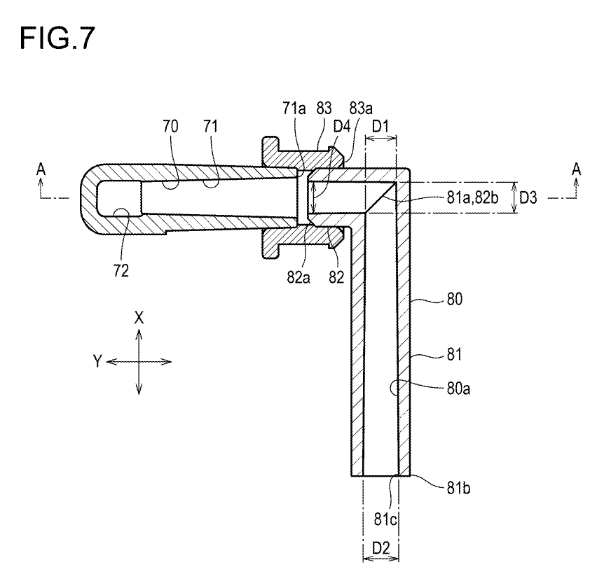

FIG. 7 is a cross-sectional view in an axial direction of the extension pipe 80. In other words, FIG. 7 is a cross-sectional view of the extension pipe 80 and the communication passage 70 taken along line A-A illustrated in FIG. 6. FIG. 4 is a cross-sectional view along line A-A illustrated in FIG. 7.

As illustrated in FIG. 5, the opposing plate 55 and the extension pipe 80 are disposed on the inner side of the surrounding wall 52e.

The extending portion 81 of the extension pipe 80 extends in, for example, the X direction.

As illustrated in FIG. 7, the inner-cavity region of the extending portion 81 communicates with the inner-cavity region of the intersecting portion 82 at one end 81a of the extending portion 81. In other words, the inner-cavity region of the intersecting portion 82 communicates with the inner-cavity region of the extending portion 81 at the other end 82b of the intersecting portion 82.

An opening 81c that is opened in the secondary-side space 62 is formed at the other end 81b of the extending portion 81 (refer to FIG. 5).

The upstream end 63a, which is the upstream end of the through-hole formed in the upstream-side supply-passage constituting member 56, may be regarded as the upstream end of the gas supply passage 63. Alternatively, an opening 52f of the first through-hole 52b on the secondary-side space 62 side, which is formed in the main wall portion 52a of the case 52 may be regarded as the upstream end of the gas supply passage 63.

In this manner, the two-stroke engine 90 includes the case 52 that defines the secondary-side space (the secondary-side space 62) together with the air filter, and the case 52 includes the main wall portion 52a that intersects (for example, orthogonal to) the axial direction of the gas supply passage and has the opened upstream end (opening 52f) of the gas supply passage 63.

The extension pipe 80 includes the extending portion 81 that extends along the main wall portion 52a, and the one end 81a of the extending portion 81 is opened in the secondary-side space (the secondary-side space 62).

Since the extension pipe 80 includes the extending portion 81, it is possible to secure a longer tube length of the extension pipe 80 while suppressing an increase in the volume of the secondary-side space 62.

The extending portion 81 preferably extends in parallel to the main wall portion 52a. Accordingly, the extending portion 81 having a necessary tube length can be disposed in a smaller space in the Y direction.

More specifically, the extension pipe 80 includes the extending portion 81 that extends along the main wall portion 52a, and the intersecting portion 82 that intersects (for example, orthogonal to) the extending portion 81 and is added to the one end of the communication passage 70 (the opening part 71a). The end (other end 81b) of the extending portion 81 on a side opposite to the intersecting portion 82 is opened in the secondary-side space (secondary-side space 62).

Since the extension pipe 80 includes the intersecting portion 82, for example, it is possible to easily connect the first part 71 and the extension pipe 80, each extending in a direction that intersects (for example, orthogonal to) the extending portion 81.

In the present embodiment, a diameter D2 is larger than a diameter D1 as illustrated in FIG. 7. In other words, the inner-cavity region of the extending portion 81 is enlarged from the one end 81a side toward the other end 81b side (opening 81c side). More specifically, the inner-cavity region of the extending portion 81 is enlarged in a tapered shape from the one end 81a side toward the other end 81b side (opening 81c side).

In this manner, an inner-cavity region of the extension pipe 80 is enlarged from an intermediate portion in a tube direction toward the end (other end 81b) of the extension pipe 80 on the side opposite to the communication passage 70.

Accordingly, it is possible to sufficiently secure the inner-cavity region 80a of the extension pipe 80 while suppressing the tube length of the extension pipe 80 (to a degree that the extension pipe 80 can be easily accommodated in the secondary-side space 62).

In the present embodiment, a diameter D4 is larger than a diameter D3 as illustrated in FIG. 7. In other words, the inner-cavity region of the extending portion 81 is enlarged from the other end 82b side toward the one end 82a side (communication passage 70 side).

In other words, this is a structure in which the extension pipe 80 includes a constricted portion at the intermediate portion in the tube direction. Accordingly, it is possible to secure an appropriate pressure loss for air flow in the extension pipe 80.

According to examinations by the inventors of the present application, the passage length of the compensator passage of the two-stroke engine 90 incorporated in the brush cutter 100 is, for example, preferably equal to or more than 50 mm and equal to or less than 200 mm, more preferably equal to or more than 70 mm and equal to or less than 120 mm, and further more preferably 90 mm approximately. The tube length of the extension pipe 80 is, for example, preferably equal to or more than 20 mm and equal to or less than 50 mm, and further more preferably 40 mm approximately.

The inner diameter of the inner-cavity region 80a of the extension pipe 80 is, for example, preferably equal to or more than 3.0 mm and equal to or less than 5.0 mm, and further more preferably 4.0 mm approximately (the cross-sectional area of the inner-cavity region 80a of the extension pipe 80 is preferably equal to or more than 7 mm² and equal to or less than 20 mm², and further more preferably 12 mm² approximately).

Note that a check valve, an adjustment valve for adjusting flow rate, and the like may be provided between the fuel tank 30 and the metering chamber 65. These are the same as in the configuration of a two-stroke engine for a typical handheld working device.

The two-stroke engine 90 is configured as described above.

In the configuration of the two-stroke engine 90, the diaphragm-type carburetor 50 is constituted by the gas supply passage 63, the metering chamber 65, the fuel nozzle 67, the diaphragm 66, and the like.

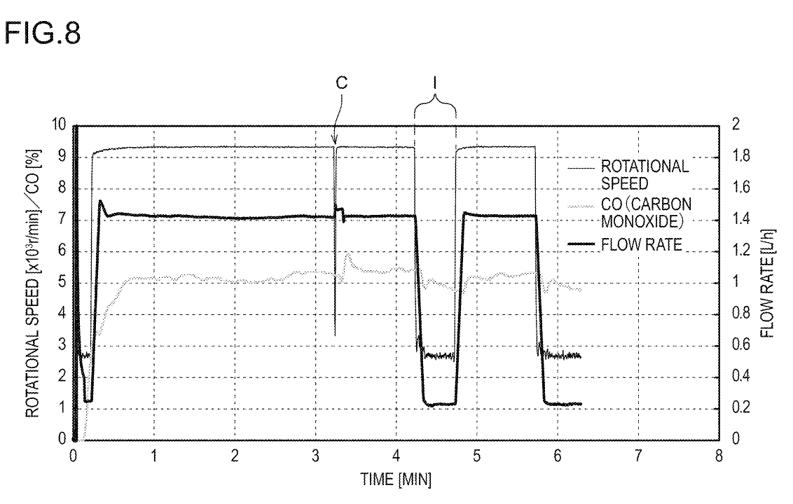

FIG. 8 is a diagram illustrating results of confirming stability of the amount of carbon monoxide emission in the brush cutter 100 according to the present embodiment.

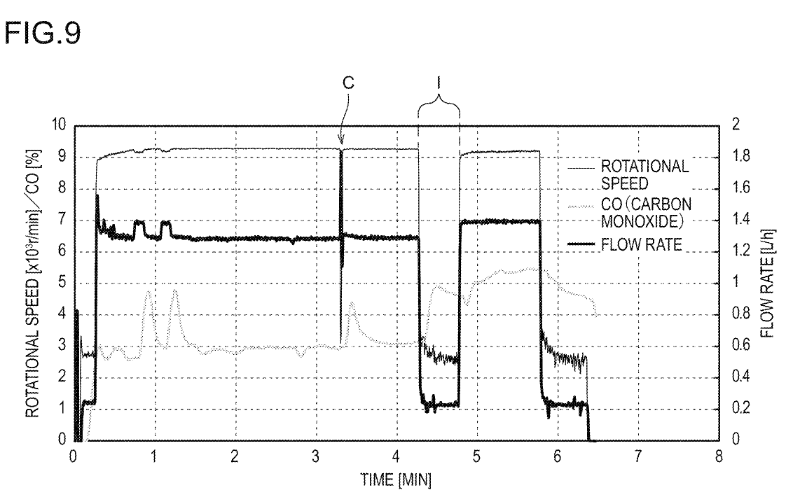

FIG. 9 is a diagram illustrating results of confirming stability of the amount of carbon monoxide emission in a brush cutter according to a reference embodiment. The brush cutter according to the reference embodiment is different from the brush cutter 100 according to the present embodiment in that the brush cutter according to the reference embodiment does not include the extension pipe 80, and is configured in the same manner as the brush cutter 100 according to the present embodiment in other points.

FIGS. 8 and 9 each include a curve (thin black solid line) representing a rotational speed, a curve (gray solid line) representing the amount of carbon monoxide emission, and a curve (thick black solid line) representing the flow rate of fuel supplied from the fuel tank 30 to the metering chamber 65.

The amount of carbon monoxide emission is proportional to (has a positive correlation with) the flow rate of fuel.

In each test operation, choking C (restricting the amount of air introduced into the gas supply passage 63 by closing the choke valve 64a at start of the two-stroke engine 90) was performed at a timing after 3 minutes, and an idling duration I of 30 seconds was provided at a timing after 4 minutes.

As illustrated in FIG. 9, in the case of the brush cutter according to the reference embodiment, the flow rate is stabilized at a high level after choking C is performed or the idling duration I is provided, whereas the flow rate is at a low level until that times. In addition, variation in the amount of carbon monoxide emission is large.

On the other hand, as illustrated in FIG. 8, in the case of the brush cutter 100 according to the present embodiment, the flow rate is stabilized at a high level before choking C is performed or the idling duration I is provided, and the amount of carbon monoxide emission is also maintained at a substantially constant level.

This results from that the provision of the extension pipe 80 stabilizes the amount of fuel ejection to the gas supply passage 63, thereby achieving uniform fuel consumption.

### Modification

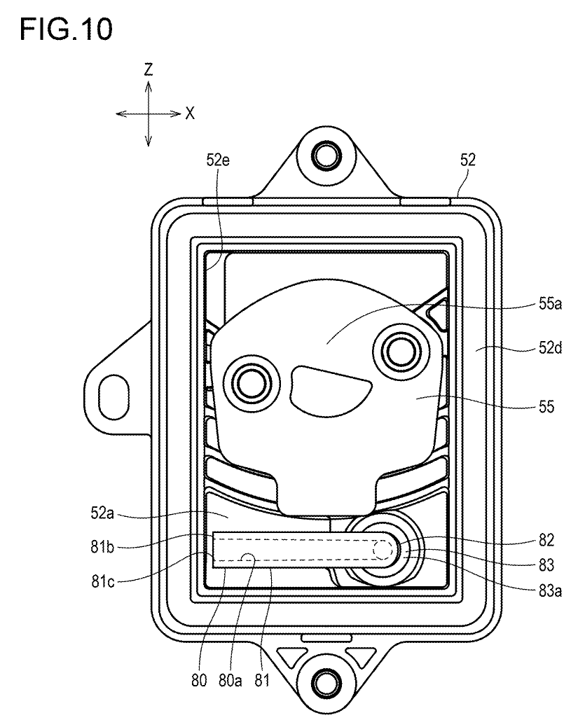

A two-stroke engine according to a modification will be described below with reference to FIG. 10.

The two-stroke engine according to the present modification is different from the two-stroke engine 90 according to the above-described embodiment in the following point, and is configured in the same manner as the two-stroke engine 90 according to the above-described embodiment in other points.

In the present modification, the extension pipe 80 is formed separately from the opposing plate 55 and is fixed relative to the case 52 independently from the opposing plate 55.

However, in the present modification as well, the compensator passage is the same as in the above-described embodiment.

Although the embodiment and the modification are described above with reference to the accompanying drawings, these are examples of the present invention, and various configurations other than those described above may be employed.

For example, in the above-described configuration, no pre-filter is provided on the inner side of the filter cover 51 and at a prior stage of the air filter 54, however, the two-stroke engine 90 may include a pre-filter disposed at a prior stage of the air filter 54.

In the above-described example, the extending portion 81 and the intersecting portion 82 of the extension pipe 80 are orthogonal to each other, however, the extending portion 81 and the intersecting portion 82 may intersect at an angle other than orthogonal.

In the above-described example, the extension pipe 80 is constituted by two parts (the extending portion 81 and the intersecting portion 82) of each having a straight tubular shape, however, the extension pipe 80 may include three or more parts of each having a straight tubular shape and intersecting each other.

In the above-described example, the extension pipe 80 is constituted by a part having a straight tubular shape, however, the extension pipe 80 may include a part bent in a curved shape.

In the above-described example, the engine intake device is for the two-stroke engine 90, however, the engine intake device may be for a four-stroke engine as long as an intake configuration (configuration of the air cleaner 60 and the diaphragm-type carburetor 50) is the same.

The present embodiment encompasses the following technical ideas.

(1) A two-stroke engine comprising a diaphragm-type carburetor and an air cleaner, wherein

the air cleaner includes an air filter,

the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the two-stroke engine further includes an extension pipe that is added to the one end of the communication passage and communicates with the communication passage, and

an end of the extension pipe on a side opposite to the communication passage is opened in the secondary-side space.

(2) The two-stroke engine according to (1), wherein the extension pipe is bent.

(3) The two-stroke engine according to (1) or (2), further comprising a case that defines the secondary-side space together with the air filter, wherein

the case includes a main wall portion that intersects an axial direction of the gas supply passage and in which an upstream end of the gas supply passage is opened,

the extension pipe includes an extending portion that extends along the main wall portion, and

one end of the extending portion is opened in the secondary-side space.

(4) The two-stroke engine according to (2), further comprising a case that defines the secondary-side space together with the air filter, wherein

the case includes a main wall portion that intersects an axial direction of the gas supply passage and in which an upstream end of the gas supply passage is opened,

the extension pipe includes an extending portion that extends along the main wall portion, and an intersecting portion that intersects the extending portion and is added to the one end of the communication passage, and

an end of the extending portion on a side opposite to the intersecting portion is opened in the secondary-side space.

(5) The two-stroke engine according to any one of (1) to (4), further comprising an opposing plate that is provided in the secondary-side space and disposed to face an upstream end of the gas supply passage, wherein

the extension pipe is integrated with the opposing plate.

(6) The two-stroke engine according to any one of (1) to (5), further comprising:
a case that defines the secondary-side space together with the air filter; and
a supply-passage constituting member including the gas supply passage, wherein
   the case and the supply-passage constituting member are disposed adjacent to each other.

(7) The two-stroke engine according to any one of (1) to (6), wherein an entirety of the extension pipe is disposed in the secondary-side space.

(8) The two-stroke engine according to any one of (1) to (7), wherein an inner-cavity region of the extension pipe is enlarged from an intermediate portion in a tube direction toward an end of the extension pipe on a side opposite to the communication passage.

(9) A portable working machine comprising a two-stroke engine including a diaphragm-type carburetor and an air cleaner, wherein

the air cleaner includes an air filter,

the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the two-stroke engine further includes an extension pipe that is added to the one end of the communication passage and communicates with the communication passage, and

an end of the extension pipe on a side opposite to the communication passage is opened in the secondary-side space.

(10) An engine intake device comprising a diaphragm-type carburetor and an air cleaner, wherein

the air cleaner includes an air filter,

the diaphragm-type carburetor includes a gas supply passage that supplies, to a primary chamber of an engine, air that has been introduced into a secondary-side space of the air filter through the air filter, a metering chamber that stores fuel supplied from a fuel tank, a diaphragm, and a communication passage that is separated from the metering chamber by the diaphragm,

when the gas supply passage becomes a negative pressure, the fuel is introduced from the metering chamber into the gas supply passage, and an air-fuel mixture in which the fuel and the air are mixed is supplied to the primary chamber,

one end of the communication passage is disposed in the secondary-side space,

the engine intake device further includes an extension pipe that is added to the one end of the communication passage and communicates with the communication passage, and

an end of the extension pipe on a side opposite to the communication passage is opened in the secondary-side space.

What is claimed is:

1. A two-stroke engine comprising a diaphragm-type carburetor and an air cleaner, wherein
the air cleaner includes an air filter,
the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,
when the gas supply passage becomes a negative pressure, the fuel is introduced from the metering chamber into the gas supply passage, and an air-fuel mixture in which the fuel and the air are mixed is supplied to the primary chamber,
one end of the communication passage is disposed in the secondary-side space,
the two-stroke engine further includes an extension pipe that is added to the one end of the communication passage and communicates with the communication passage, and
an end of the extension pipe on a side opposite to the communication passage is opened in the secondary-side space.

2. The two-stroke engine according to claim 1, wherein the extension pipe is bent.

3. The two-stroke engine according to claim 1, further comprising a case that defines the secondary-side space together with the air filter, wherein
the case includes a main wall portion that intersects an axial direction of the gas supply passage and in which an upstream end of the gas supply passage is opened,
the extension pipe includes an extending portion that extends along the main wall portion, and
one end of the extending portion is opened in the secondary-side space.

4. The two-stroke engine according to claim 2, further comprising a case that defines the secondary-side space together with the air filter, wherein
the case includes a main wall portion that intersects an axial direction of the gas supply passage and in which an upstream end of the gas supply passage is opened,
the extension pipe includes an extending portion that extends along the main wall portion, and an intersecting portion that intersects the extending portion and is added to the one end of the communication passage, and
an end of the extending portion on a side opposite to the intersecting portion is opened in the secondary-side space.

5. The two-stroke engine according to claim 1, further comprising an opposing plate that is provided in the secondary-side space and disposed to face an upstream end of the gas supply passage, wherein
the extension pipe is integrated with the opposing plate.

6. The two-stroke engine according to claim 1, further comprising:
a case that defines the secondary-side space together with the air filter; and
a supply-passage constituting member including the gas supply passage, wherein
the case and the supply-passage constituting member are disposed adjacent to each other.

7. The two-stroke engine according to claim 1, wherein an entirety of the extension pipe is disposed in the secondary-side space.

8. The two-stroke engine according to claim 1, wherein an inner-cavity region of the extension pipe is enlarged from an intermediate portion in a tube direction toward an end of the extension pipe on a side opposite to the communication passage.

9. A portable working machine comprising a two-stroke engine including a diaphragm-type carburetor and an air cleaner, wherein
the air cleaner includes an air filter,
the diaphragm-type carburetor includes a gas supply passage that supplies, to a primary chamber, air that has been introduced into a secondary-side space of the air filter through the air filter, a metering chamber that stores fuel supplied from a fuel tank, a diaphragm, and a communication passage that is separated from the metering chamber by the diaphragm,
when the gas supply passage becomes a negative pressure, the fuel is introduced from the metering chamber into the gas supply passage, and an air-fuel mixture in which the fuel and the air are mixed is supplied to the primary chamber,
one end of the communication passage is disposed in the secondary-side space,
the two-stroke engine further includes an extension pipe that is added to the one end of the communication passage and communicates with the communication passage, and
an end of the extension pipe on a side opposite to the communication passage is opened in the secondary-side space.

10. An engine intake device comprising a diaphragm-type carburetor and an air cleaner, wherein
the air cleaner includes an air filter,
the diaphragm-type carburetor includes a gas supply passage that supplies, to a primary chamber of an engine, air that has been introduced into a secondary-side space of the air filter through the air filter, a metering chamber that stores fuel supplied from a fuel tank, a diaphragm, and a communication passage that is separated from the metering chamber by the diaphragm,
when the gas supply passage becomes a negative pressure, the fuel is introduced from the metering chamber into the gas supply passage, and an air-fuel mixture in which the fuel and the air are mixed is supplied to the primary chamber,
one end of the communication passage is disposed in the secondary-side space,
the engine intake device further includes an extension pipe that is added to the one end of the communication passage and communicates with the communication passage, and
an end of the extension pipe on a side opposite to the communication passage is opened in the secondary-side space.
